(19) United States
(12) Patent Application Publication
(10) Pub. No.: US 2019/0357530 A1
(43) Pub. Date: Nov. 28, 2019

(54) BEAD COMPOSITIONS FOR AQUATIC WEED CONTROL

(71) Applicant: UPL LTD, Haldia (IN)

(72) Inventors: Prakash Mahadeo JADHAV, Lawrenceville, NJ (US); Stephen SKORCZYNSKI, Yardley, PA (US); Jaidev Rajnikant SHROFF, Dubai (AE); Vikram Rajnikant SHROFF, Dubai (AE)

(21) Appl. No.: 16/423,491

(22) Filed: May 28, 2019

Related U.S. Application Data
(60) Provisional application No. 62/728,207, filed on Sep. 7, 2018.

(30) Foreign Application Priority Data
May 25, 2018 (IN) 201831019644

(51) Int. Cl. A01N 25/12; A01N 43/90; A01N 25/10

(52) U.S. Cl. CPC A01N 25/12; A01N 25/10; A01N 43/90

(57) ABSTRACT

Disclosed are beads comprising endothall, its salts or derivatives entrapped in an alginate complex. The disclosure further relates to a process for preparing herbicidal alginate bead compositions and a method of controlling algae and aquatic weeds using the same. Further, a safe delivery system of herbicides, for aquatic weed control, comprising the bead composition is also provided.

### CROSS-REFERENCE TO RELATED APPLICATIONS

This application claims priority to Indian Provisional Application 201831019644 filed on May 25, 2018 and U.S. Provisional Application No. 62/728,207 filed on Sep. 7, 2018, both of which are incorporated herein by reference in their entirety.

### TECHNICAL FIELD

The present disclosure relates to herbicidal bead compositions for aquatic weed control. The present disclosure provides beads comprising endothall, its salts or derivatives which is being entrapped in an alginate complex. The disclosure further relates to a process for preparing herbicidal alginate bead compositions and a method of controlling aquatic weeds using such compositions. A safe delivery system of herbicides for aquatic weed control is another aspect of the present disclosure.

### BACKGROUND

Aquatic plants are natural and important components of the aquatic environment. A large number of weeds grow alongside in the water bodies disturbing the aquatic environment. Aquatic weeds are undesirable vegetation that reproduce and grow in water. Uncontrolled growth of these weeds may hamper the water bodies and create serious environmental issues.

Algae, duckweed, watermeal, water Hyacinth, water lettuce, submerged plants such as milfoil, hydrillia, curly-Leaf pondweed, clasping-leaf pondweed, coontail, naiad, sago pondweed, emergent plants such as cattail, water lily, watershield, phragmites, purple loosestrife and bulrush are common aquatic plants that need to be controlled.

Algae forms the base of the aquatic food chain and plays an important role in wastewater stabilization in ponds through photosynthetic oxygen evolution that enhances the aerobic degradation of organic matter. However, due to the high nutrient loads in ponds, algae grows excessively often leading to the development of dense algal blooms causing high concentrations of total suspended solids which may have a detrimental effect on a body of water and its inhabitants. In some cases, blue-green algae can produce toxins that cause animal sickness or death.

Several herbicides have been utilized to control the densities of algal populations. Endothall is one of the widely used algicides. It is a selective contact herbicide, absorbed by the leaves and roots, with limited acropetal translocation in the xylem. Amine, ammonium and alkali-metal salts of endothall are commonly used pre- and post-emergence for control of annual grass and broad-leaved weeds in sugar beet, fodder beet, beetroot, spinach and turf. Endothall and its derivatives can be used for aquatic weed control in rice.

Aquatic herbicides generally are available in sprayable or granular formulations. However, this often lead to safety issues for workers due to exposure during application. It further leads to skin burn and irritation as well as eye sensitization.

U.S. Pat. Nos. 4,400,391 and 4,401,456 disclose alginate gel bead composition of herbicides and insecticides. Although these patents disclose processes for the preparation of alginate gel bead compositions, the products that were prepared by the process had active ingredients in very low concentration and an alginate polymer matrix in high concentrations. Further, the storage stability of the product as well as various essential product parameters were not well defined for effective preparation and use for the intended pesticide activity.

There is therefore a need to develop safer and more effective herbicide products as well as safe delivery system for products, particularly for aquatic weed control.

Described herein are novel herbicidal bead compositions comprising endothall for aquatic weed control.

### SUMMARY

In an aspect, a bead composition comprises
a) an external zone comprising an alginate complex; and
b) an internal zone comprising
   i) at least 15% by weight of endothall, its salts or derivatives, based on the total weight of the beads; and
   ii) at least one additive,

wherein said external zone is capable of releasing said endothall, its salts or derivatives when hydrated.

In another aspect, a bead composition suspended in a medium comprises
a) an external zone comprising an alginate complex; and
b) an internal zone comprising
   i. at least 15% by weight of endothall, its salts or derivatives, based on the total weight of the beads; and
   ii. at least one additive,
wherein said external zone is capable of releasing, said endothall, its salts or derivatives when hydrated.

In another aspect, a process for preparing an herbicidal bead composition comprises
a) preparing a pre-gel mixture comprising at least 15% by weight of endothall, its salts or derivatives, based on the total weight of the beads, a water soluble alginate salt, and an additive;
b) preparing a gelling bath mixture comprising an alkaline earth metal solution; and
c) dispensing uniform droplets of the pre-gel mixture into the gelling bath mixture to form said herbicidal beads entrapping the endothall, its salts or derivatives and the at least one additive in an internal zone.

In yet another aspect, a process for preparing an herbicidal bead composition comprises
a) preparing a pre-gel mixture part A;
b) preparing a gelling bath mixture part B;
c) dispensing uniform droplets of part A into part B;
d) allowing the mixture to form said herbicidal beads entrapping endothall, its salts or derivatives and the at least one additive in an internal zone;
e) separating said beads;
f) optionally drying said beads; and
   g) optionally suspending said beads in a medium, wherein part A comprises at least 15% by weight of the endothall, its salts or derivatives, based on the total weight of the beads, a water soluble alginate salt, and at least one additive; and part B comprises an alkaline earth metal solution.

In another aspect, a continuous process for preparing an herbicidal bead composition comprises
a) preparing a pre-gel mixture part A;
b) preparing a gelling bath mixture part B in a container with an inlet and outlet so as to optimize a continuous flow of gelling bath mixture part B;
c) dispensing uniform droplets of part A into part B;
d) allowing the mixture to form said beads instantly entrapping endothall, its salts or derivatives and the at least one additive in and internal zone;
e) separating said beads continuously;
f) optionally drying said beads in a continuous drier; and
g) optionally suspending said beads in a medium,

wherein parts A and B are as described above.

Further, described herein is a method of controlling aquatic weeds, said method comprising applying to the weeds in water bodies an agronomically effective amount of a bead composition comprising
a) an external zone comprising an alginate complex; and
b) an internal zone comprising
   i. at least 15% by weight of endothall, its salts or derivatives, based on the total weight of the beads; and
   ii. at least one additive.

Further included is a safe delivery system for aquatic weed control, said system comprising a bead composition comprising:
a) an external zone comprising an alginate complex; and
b) an internal zone comprising
   i. at least 15% by weight of endothall, its salts or derivatives, based on the total weight of the beads; and
   ii. at least one additive.

### DETAILED DESCRIPTION

The inventors observed that a bead composition comprising endothall can be prepared for safe and effective use for aquatic weed control.

Accordingly, described herein is a novel delivery system for endothall for aquatic weed control.

It has been noted that a high concentration of endothall can be incorporated in the bead composition that can be delivered safely for the intended use of aquatic weed control. It has been further noted that the bead composition described herein can be stored effectively. It has been observed that the bead composition comprising an additive lead to many advantages for the product. The additive acts as a conditioner for the bead composition providing delivery of the herbicide in a most effective way. These and the many other aspects of the invention are described hereinafter.

Thus, a bead composition comprises
a) an external zone comprising an alginate complex; and
b) an internal zone comprising:
   i. at least 15% by weight of endothall, its salts or derivatives, based on the total weight of the beads; and
   ii. at least one additive;
wherein said external zone is capable of releasing said endothall, its salts or derivatives when hydrated.

In certain embodiments, the beads are spherical in shape.

In certain embodiments, the external zone comprises an alginate gel complex. In some embodiments, the alginate complex is an alkali or alkaline earth metal salt of alginic acid. In some other embodiments, the alginate complex is sodium or calcium alginate. In some preferred embodiments, the alginate complex is calcium alginate.

In an embodiment, the internal zone is entrapped in the external zone. In another embodiment, the internal zone is entrapped in the alginate complex. In certain embodiments, the internal zone comprises endothall.

As used herein, endothall comprises, its salts and derivatives. Endothall salts include alkali-metal salts, ammonium and amine salts. Preferred endothall salts include endothall diammonium, endothall dipotassium, endothall disodium and endothall mono(N,N-dimethylalkylammonium), and combinations thereof.

Throughout the specification, the term ‘endothall’ refers to endothall, its salts and derivatives.

In certain embodiments, the internal zone of the beads comprises at least 15% by weight of endothall, based on the total weight of the beads. In certain other embodiments, the internal zone comprises from about 15% to about 99% by weight of endothall, based on the total weight of the beads In some other embodiments, the internal zone according from about 50% to about 99% by weight of endothall, based on the total weight of the beads

In an embodiment the internal zone is in the form of a solution. In another embodiment, the internal zone is in the form of a dispersion.

In an embodiment, the internal zone according comprises at least one additive. In an embodiment, the additive acts as a surface modifying agent for the bead composition. In another embodiment, the additive acts as a surface modifying agent that optimizes the plasticity of the bead, thereby releasing the active ingredient in an effective manner. In another embodiment, the additive acts as a surface modifying agent that improves the permeability of the external zone of the bead, thereby controlling the release of herbicidal endothall to the aquatic environment where weed control is required. In yet another embodiment, the additive is a polymer. In a preferred embodiment, the additive is polyvinyl alcohol.

In certain embodiments, the internal zone of the beads described herein further comprises at least one agrochemical excipient.

Accordingly, in an aspect, a bead composition comprises
a) an external zone comprising an alginate complex; and
b) an internal zone comprising
   i. at least 15% by weight of endothall, its salts or derivatives, based on the total weight of the beads;
   ii. at least one additive; and
   iii. at least one agrochemical excipient.

Exemplary agrochemical excipients include surfactants, solvents, solubilizing agents, biocides, viscosity modifiers, gums, stabilizers, and combinations thereof. In certain preferred embodiments, the agrochemical excipient is selected from surfactants, biocides, stabilizers, and combinations thereof.

In certain embodiments, the internal zone comprises a solution comprising endothall, an additive, and at least one agrochemical excipient. In certain other embodiments, the internal zone comprises a dispersion comprising endothall, an additive and at least one agrochemical excipient.

The present disclosure further provides a bead composition, suspended in a medium, said bead composition comprising
a) an external zone comprising an alginate complex; and
b) an internal zone comprising
   i. at least 15% by weight of endothall, its salts or derivatives, based on the total weight of the beads; and
   ii. at least one additive;
wherein said external zone is capable of releasing said endothall, its salts or derivatives when hydrated.

In certain embodiments, the bead composition according to the present disclosure is suspended in a medium. In an embodiment, the internal zone is non-permeable to the suspending medium.

In certain embodiments, the suspending medium comprises saturated polysaccharide solution, saturated xanthan gum solution, or a saturated solution of alginate salts.

In certain other embodiments, the suspending media comprises saturated sugar solution, saturated starch solution, or saturated calcium alginate solution.

Therefore, in an aspect, a process for preparing an herbicidal bead composition comprises
a) preparing a pre-gel mixture comprising at least 15% by weight of endothall, its salts or derivatives, based on the total weight of the beads, a water soluble alginate salt, and an additive;
b) preparing a gelling bath mixture comprising an alkaline earth metal solution; and
c) dispensing uniform droplets of the pre-gel mixture into the gelling bath mixture to form beads entrapping an internal zone comprising the endothall, its salts or derivatives and the additive.

In another aspect, the invention provides a continuous process for preparing an herbicidal bead composition comprising steps of:
a) preparing a pre-gel mixture comprising at least 15% by weight of endothall, its salts or derivatives, based on the total weight of the beads, a water soluble alginate salt, and an additive;
b) preparing a gelling bath mixture comprising an alkaline earth metal solution in a container with an inlet and outlet so as to optimize a continuous flow of gelling bath mixture;
c) dispensing uniform droplets of pre-gel mixture into the gelling bath mixture to form said beads entrapping an internal zone comprising the endothall, its salts or derivatives and the additive; and
d) separating said beads continuously.

These process aspects may have more preferred embodiments comprising additional preferred steps.

Thus, in an embodiment, the present disclosure further provides a process for preparing an herbicidal bead composition, said process comprising
a) preparing a pre-gel mixture comprising at least 15% by weight of endothall, its salts or derivatives, based on the total weight of the beads, a water soluble alginate salt and an additive;
b) preparing a gelling bath mixture comprising an alkaline earth metal solution;
c) dispensing uniform droplets of the pre-gel mixture into the gelling bath mixture;
d) allowing the mixture to form said beads entrapping an internal zone comprising the endothall, its salts or derivatives and the additive;
e) separating said beads;
f) optionally drying said beads; and
g) optionally suspending said beads in a medium.

Further provided is a continuous process for preparing an herbicidal bead composition, said process comprising
a) preparing a pre-gel mixture part A;
b) preparing a gelling bath mixture part B in a container with continuous flow system of gelling bath mixture part B;
c) dispensing uniform droplets of part A into part B;
d) allowing the mixture to form said beads instantly entrapping said internal zone;
e) separating said beads continuously;
f) optionally drying said beads in a continuous drier; and
g) optionally suspending said beads in a media.

In an embodiment, provided is a continuous process for preparing bead compositions according to the present disclosure.

In another embodiment, the pre-gel mixture part A comprises endothall, its salts or derivatives, a water soluble alginate salt and an additive.

In another embodiment, the pre-gel mixture part A comprises at least 15% by weight of endothall, based on the total weight of the beads, its salts or derivatives, a water soluble alginate salt and an additive. In some embodiments, the water soluble alginate salt is sodium alginate. In some other embodiments, the additive is a polymer. In some preferred embodiments, the polymer is polyvinyl alcohol. In certain embodiments, the gelling bath mixture part B comprises an alkaline earth metal salt solution. In certain other embodiments, the gelling bath mixture part B comprises an alkaline earth metal salt solution and at least one agrochemical excipient. In certain preferred embodiments, the gelling bath mixture part B comprises calcium chloride solution and at least one agrochemical excipient. In some other embodiments, the gelling bath mixture part B comprises calcium chloride solution and a biocide.

The process of making uniform droplets of pre-gel mixture part A is not particularly limiting. In an embodiment, the temperature of pre-gel mixture part A is in a range from about 0° C. to about 60° C.

In an embodiment, the temperature of pre-gel mixture part A is in a range from about 5° C. to about 35° C.

The viscosity of the of pre-gel mixture part A is regulated depending on the requirement of size and shape of the bead composition.

The process of dispensing uniform droplets of pre-gel mixture part A into gelling bath mixture part B is not particularly limiting. In an embodiment, pre-gel mixture part A is passed through an appropriate nozzle to form uniform droplets. In an embodiment, the delivery of uniform droplets of pre-gel mixture part A into gelling bath mixture part B is accomplished by pressure actuated system, gravity feed through stationary nozzle or by appropriate encapsulation system. In another embodiment, the delivery of uniform droplets of pre-gel mixture part A into gelling bath mixture part B is accomplished by a suitable sprayer system.

The process of forming the bead composition by mixing uniform droplets of pre-gel mixture part A with gelling bath mixture part B is not particularly limiting. In an embodiment, the process of forming the bead composition by mixing uniform droplets of pre-gel mixture part A with gelling bath mixture part B is performed in a continuous manner. In another embodiment, the gelling bath mixture part B is positioned with a continuous flow system in a container with an inlet and an outlet to maintain uniform concentration of the gelling bath mixture. In some embodiments, the beads are formed instantly while dropping pre-gel mixture part A into gelling bath mixture part B.

In some another embodiments, the beads with uniform wall thickness are formed while dropping pre-gel mixture part A into gelling bath mixture part B. In certain embodiments, the wall thickness of beads are optimized for controlled release of endothall during application. In certain other embodiments, the wall thickness of beads are optimized by controlling the concentration of gelling bath mixture part B. In some embodiments, the concentration of gelling bath mixture part B is controlled by the continuous flow system. The contact time of droplets of pre-gel mixture part A with gelling bath mixture part B is kept for period less than that permits osmotic loss of endothall to the gelling bath mixture part B. In an embodiment, the contact time of droplets of pre-gel mixture part A with gelling bath mixture part B is less than 25 seconds.

In an embodiment, the temperature of gelling bath mixture part B is in a range from about 0° C. to about 50° C. In another embodiment, the temperature of gelling bath mixture part B is in a range from about 5° C. to about 35° C. In a preferred embodiment, the temperature of gelling bath mixture part B is in a range from about 5° C. to about 20° C.

In an embodiment, the beads are spherical in shape. In another embodiment, the size of the beads ranges from about 0.1 mm to about 3 mm in diameter. In a preferred embodiment, the size of the beads ranges from about 0.5 mm to about 2 mm in diameter.

In some embodiments, the beads are separated continuously. In an embodiment, the beads are separated by a strainer or by a moving mesh belt system. In some embodiments, beads are dried passively at room temperature by natural evaporation of water.

In some embodiments, the beads are dried by suitable drier. In some other embodiments, the beads are dried by air flow dryer or fluid bed drier. In an embodiment the beads are dried using a continuous dryer.

In another embodiment, the continuous dryer can be a custom made dryer with optimized temperature and pressure conditions. In yet another embodiment, the continuous dryer can be selected from rotary vapour dryer, rotary drum dryer, spin flash dryer. In an embodiment, the process of drying the beads is industrially viable. In certain embodiments, the beads are dried to contain up to 50% by weight of water.

In some embodiments, the beads are suspended in a suitable medium. Exemplary media include saturated polysaccharide solution, saturated xanthan gum solution, and a saturated solution of alginate salts. In certain other embodiments, the suspending medium comprises saturated sugar solution, saturated starch solution, or saturated calcium alginate solution.

In some embodiments, the finished beads are packed in water soluble bags. In some other embodiments, the beads are packed in a suspending medium that is ready to be dispersed for the intended use as a herbicide.

In some embodiments, provided herein is an advantageous continuous process to prepare bead compositions of endothall.

The advantages of the continuous process include
a) a. a high yielding process (above 95%),
b) beads with optimized wall thickness, capable of releasing endothall in a controlled manner,
c) beads with high concentration of endothall,
d) minimum effluent, and
e) minimum loss of endothall in effluent.

Further, provided herein is a method of controlling aquatic weeds, said method comprising applying to the weeds in water bodies an agronomically effective amount of a bead composition comprising
a) an external zone comprising an alginate complex; and
b) an internal zone comprising
   i. at least 15% by weight of endothall, its salts or derivatives, based on the total weight of the beads; and
   ii. at least one additive.

In an embodiment, the bead composition is used for controlling algae and aquatic plants such as duckweed, watermeal, water Hyacinth, water lettuce, submerged plants such as milfoil, hydrillia, curly-Leaf pondweed, clasping-leaf pondweed, coontail, naiad, sago pondweed, emergent plants such as cattail, water lily, watershield, phragmites, purple loosestrife and bulrush.

In another embodiment, algae includes sensitive species such as Spirogyra and Pithophora and difficult to control species such as Nostoc and Oedogonium.

Further provided herein is a safe delivery system for aquatic weed control, said system comprising a bead composition comprising
a) an external zone comprising an alginate complex; and
b) an internal zone comprising:
   i. at least 15% by weight of endothall, its salts or derivatives, based on the total weight of the beads; and
   ii. at least one additive.

In an embodiment, provided is a safe delivery system for aquatic weed control, said system comprising an endothall composition in the form of beads that can be delivered to water bodies safely.

In another embodiment, the safe delivery system according to the present disclosure avoids direct exposure and skin irritation due to endothall.

The instant invention is more specifically explained by below examples. However, it should be understood that the scope of the present invention is not limited by the examples in any manner. It will be appreciated by any person skilled in this art that the present invention includes below examples and further can be modified and altered within the technical scope of the present invention.

### EXAMPLES

### Example 1

A bead composition according to the present disclosure was prepared as follows:

Composition of pre-gel mixture part A:

| Ingredients | Quantity (% w/w) |
|---|---|
| Endothall amine salt | 98.75 |
| Sodium alginate | 0.75 |
| Polyvinyl alcohol | q.s |

Composition of gelling bath mixture part B:

| Ingredients | Quantity (% w/w) |
|---|---|
| Calcium chloride hexahydate | 15 |
| Proxel ™ gel | 2 |
| Water | q.s. |

Composition of bead:

| Ingredients | Quantity (% w/w) |
|---|---|
| Endothall amine salt | 94.3 |
| Polyvinyl alcohol | 0.48 |
| Sodium alginate | 0.72 |
| Proxel ™ gel | 0.1 |
| Calcium alginate shell | 4.4 |

### Process:

The required quantity of ingredients for part A was mixed well to form the pre-gel mixture. The gelling bath mixture part B was prepared by mixing the required ingredients in a separate container having a continuous flow system. Pre-gel mixture part A as prepared above was dispensed dropwise to the gelling bath mixture part B kept at a temperature of 10-15° C. The mixture was kept under stirring. The beads were formed instantly and the contact time of part A in part B was controlled to be less than 15 seconds to obtain the beads of required size and wall thickness. The beads were continuously separated and dried using a continuous dryer.

### Example 2

A comparative composition was prepared (in the absence of polyvinyl alcohol) as follows:

Composition of pre-gel mixture part A:

| Ingredients | Quantity (% w/w) |
|---|---|
| Endothall amine salt | 99.25 |
| Sodium alginate | 0.75 |

Composition of gelling bath mixture part B:

| Ingredients | Quantity (% w/w) |
|---|---|
| Calcium chloride hexahydrate | 15.0 |
| Proxel ™ GXL | 2.0 |
| Water | QS |

Composition of bead:

| Ingredients | Quantity (% w/w) |
|---|---|
| Endothall amine salt | 94.78 |
| Sodium alginate | 0.72 |
| Proxel ™ GXL | 0.10 |
| Calcium alginate shell | 4.40 |

The process for Example 1 was used to prepared the composition.

### Weed Control Observations:

The bead compositions prepared according to the present disclosure were tested on various aquatic weeds for their herbicidal activity.

In the present study, the algicidal activity of bead compositions was tested. Algae samples were dominated by Spirogyra, however, other species such as Zygnema and Pithophora were present. Difficult to control species Nostoc and Oedogonium were also present. The bead composition of endothall amine salt at a concentration (0.07 mg acid equivalent/liter) was tested and observations were recorded for 1 day, 3 days and 5 days after exposure. Algae exposed to various concentrations had degraded cells 5 days post-exposure initiation. Chlorophyll concentrations for all exposures were less than half of the untreated controls. The algae in the untreated controls remained green with intact cellular structure throughout the 5 day experiment.

The results are summarized in the below table.

| Treatment (mg acid | Chlorophyll concentration (g/g algae) | | |
|---|---|---|---|
| equivalent/liter) | 1 DAT | 3 DAT | 5 DAT |
| 0.07 (Example 1) | 30 | 80 | 20 |
| 0.07 (Example 2) | 114 | 187 | 85 |
| Control | 260 | 300 | 290 |

From the results as shown in the above table, it is evident that the bead compositions according to the present invention can be effectively used for algae control. Without being held to theory, it is believed that the additive acts as a structure modifying agent which in turn affected the permeability of the bead wall thereby controlling the release of endothall for the intended algae control. When treating an algae complex, multiple species within the complex should be considered. With the species differentiation comes differential tolerances and susceptibility of the various species being treated. When the most susceptible algal species dominates, it is easily controlled when treated.

It has been observed that sensitive species are Spirogyra and Pithophora. Nostoc and Oedogonium were noted as species that are difficult to control. With the death of the most susceptible and most dominant species, secondary, more tolerant species can proliferate. The secondary species then increase in percentage because of the lack of the competing susceptible species, and the secondary more tolerant species use the nutrient release from the susceptible species as a nutrient source to “bloom”. Yet, as time increases the secondary species tolerance was observed to be overcome by the continued exposure to the algaecide compositions described herein. Due to the continued exposure over a few days, the secondary more tolerant species also succumbed to the algaecide application according to the present disclosure. This observation is supported by the data provided in the table.

The use of the terms “a” and “an” and “the” and similar referents (especially in the context of the following claims) are to be construed to cover both the singular and the plural, unless otherwise indicated herein or clearly contradicted by context. The terms first, second etc. as used herein are not meant to denote any particular ordering, but simply for convenience to denote a plurality of, for example, layers. The terms “comprising”, “having”, “including”, and “containing” are to be construed as open-ended terms (i.e., meaning “including, but not limited to”) unless otherwise noted. Recitation of ranges of values are merely intended to serve as a shorthand method of referring individually to each separate value falling within the range, unless otherwise indicated herein, and each separate value is incorporated into the specification as if it were individually recited herein. The endpoints of all ranges are included within the range and independently combinable. All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

1. A bead composition comprising
a) an external zone comprising an alginate complex; and
b) an internal zone comprising
i) at least 15% by weight of endothall, its salts or derivatives, based on the total weight of the beads; and
ii) at least one additive
wherein said external zone is capable of releasing said endothall, its salts or derivatives when hydrated.

2. The bead composition according to claim 1, wherein said alginate complex is an alkali or alkaline earth metal salt of alginic acid.

3. The bead composition according to claim 1, wherein said alginate complex is sodium or calcium alginate.

4. The bead composition according to claim 1, wherein said internal zone is entrapped in said external zone.

5. The bead composition according to claim 1, wherein said endothall is selected from the group consisting of endothall diammonium, endothall dipotassium, endothall disodium, and endothall mono(N,N-dimethylalkylammonium).

6. The bead composition according to claim 1, wherein said internal zone comprises from about 15% to about 99% by weight of endothall.

7. The bead composition according to claim 1, wherein said additive is a polymer.

8. The bead composition according to claim 1, wherein said additive is polyvinyl alcohol.

9. The bead composition of claim 1, suspended in a medium.

10. The bead composition according to claim 9, wherein said suspending medium is selected from saturated polysaccharide solution, saturated xanthan gum solution, and a saturated solution of alginate salts.

11. A process for preparing an herbicidal bead composition, comprising
a) preparing a pre-gel mixture comprising at least 15% by weight of endothall, its salts or derivatives, based on the weight of the beads, a water soluble alginate salt and an additive;
b) preparing a gelling bath mixture comprising an alkaline earth metal solution; and
c) dispensing uniform droplets of the pre-gel mixture into the gelling bath mixture to form said beads entrapping an internal zone comprising the endothall, its salts or derivatives and the additive.

12. The process according to claim 12, wherein said water soluble alginate salt is calcium alginate.

13. The process according to claim 12, wherein said gelling bath mixture comprises calcium chloride solution and a biocide

14. A continuous process for preparing an herbicidal bead composition, comprising
a) preparing a pre-gel mixture comprising at least 15% by weight of endothall, its salts or derivatives, based on the total weight of the beads, a water soluble alginate salt, and an additive;
b) preparing a gelling bath mixture comprising an alkaline earth metal solution in a container with an inlet and outlet so as to optimize a continuous flow of the gelling bath mixture;
c) dispensing uniform droplets of the pre-gel mixture into the gelling bath mixture to form said beads entrapping an internal zone comprising the endothall, its salts or derivatives and the additive; and
d) separating said beads continuously

15. A method of controlling algae or aquatic weeds, said method comprising applying to the algae or aquatic weeds in a water body an agronomically effective amount of a bead composition according to claim 1.

16. The method according to claim 15, wherein said aquatic weed is selected from duckweed, watermeal, water Hyacinth, water lettuce, milfoil, hydrillia, curly-Leaf pondweed, clasping-leaf pondweed, coontail, naiad, sago pondweed, cattail, water lily, watershield, phragmites, purple loosestrife, and bulrush.

17. A safe delivery system for algae or aquatic weed control, said system comprising a bead composition according to claim 1.
